(19) United States
(12) Patent Application Publication
(10) Pub. No.: US 2005/0246671 A1
(43) Pub. Date: Nov. 3, 2005

(54) Method and apparatus for determining worst case coupling within a differential pair group

(76) Inventors: Karl J. Bois, Fort Collins, CO (US); David W. Quint, Fort Collins, CO (US); Mark D. Frank, Longmont, CO (US); Jerimy Nelson, Fort Collins, CO (US)

Correspondence Address: HEWLETT-PACKARD COMPANY;Intellectual Property Administration, P.O. BOX 272400, Fort Collins, CO, 80527-2400, US

(21) Appl. No.: 11/089,568

(22) Filed: Apr. 29, 2004

(51) Int. Cl. G06F 17/50

(52) U.S. Cl. 716/5; 716/8; 716/12

(57) ABSTRACT

A method for calculating worst case coupling for a differential pair group includes identifying a victim differential pair and at least one culprit differential pair in the differential pair group, calculating a coupling factor between each of the culprit differential pairs and the victim differential pair, and summing the absolute value of each of the coupling factors to generate a worst case coupling factor.

### BACKGROUND

Explosive growth in electronics technology has resulted in electronic devices used all around us in seemingly every facet of life. For example, communications equipment, toys, computers, automobiles, personal digital assistants (PDAs), household appliances, medical equipment, etc., all include increasingly powerful electronic circuits. As electronic devices become more powerful, however, their design and manufacture has become more complex and sensitive, particularly as their speed increases.

Although the design and manufacture of electronic circuits may be carried out in a number of ways, two steps in the design process are practically universal: first, the logical or functional design of the circuits, and second, the physical design of the circuits. In the first step, a circuit design is created in which circuit elements are selected and interconnected to implement the desired functionality of the circuit. The result of this functional design step is a logical circuit design file describing the interconnections in the circuit, such as “L1_pin A is connected to L2_pin B”.

The second of these two design steps is to generate a physical circuit layout from the logical circuit design for the desired product, such as an integrated circuit (IC), an IC package, a printed circuit board, etc. The circuit layout can be used to form a mask which can be provided to a foundry for fabrication. For example, the circuit layout describes the conductive lines or traces including their width, shape and position, and the conductive vias which connect the traces on different circuit layers.

Many aspects of the physical layout of conductive traces must be carefully controlled in order for the circuit to operate properly. For example, properties such as trace widths, minimum trace spacing, minimum and maximum trace length, etc., impact the electrical characteristics of the circuit such as signal delay and distortion. One potential source of errors during the operation of an electrical circuit is crosstalk, or interference caused by two signals becoming partially superimposed on each other due to electromagnetic (inductive) or electrostatic (capacitive) coupling between the conductive traces carrying the signals. A common example of crosstalk is where the magnetic field from changing current flow in one conductive trace induces current in another conductive trace running parallel to the first. The coupling from one conductive trace to another may be measured as the ratio of the power in a disturbing trace (the culprit) to the induced power in the disturbed trace (the victim). The coupling factor may be expressed in any suitable fashion, such as in decibels (dB) or as a percentage, or as a ratio, etc. For example, when expressed as a ratio, a coupling factor of 0 indicates that no coupling exists, and a factor of 1 indicates that the culprit trace is entirely coupled to the victim trace, so that 100% of a signal on the culprit trace will appear on the victim trace.

Circuit designers can attempt to minimize coupling between conductive traces by simulating the circuit layout and making adjustments to the layout if coupling problems appear. However, manually calculating the coupling factor for conductive traces in a complex electrical circuit is extremely tedious and difficult, particularly when the electrical circuit includes differential pairs. A differential pair is a pair of conductive traces, typically (but not always) routed parallel to each other through the electrical circuit. The exemplary differential pair is balanced, with each trace in the differential pair theoretically carrying equal but opposite currents called odd-mode signals. Because the differential pair contains two traces with opposite polarity on the traces, calculation of coupling factors involving differential pairs is difficult.

### SUMMARY

An exemplary embodiment may comprise a method for calculating worst case coupling for a differential pair group, including identifying a victim differential pair and at least one culprit differential pair in the differential pair group, calculating a coupling factor between each of the culprit differential pairs and the victim differential pair, and summing the absolute value of each of the coupling factors to generate a worst case coupling factor.

### BRIEF DESCRIPTION OF THE DRAWINGS

Illustrative embodiments are shown in the accompanying drawings as described below.

FIG. 1 is a cross-sectional end view of an exemplary differential pair group made up of differential trace pairs in an electrical circuit.

FIG. 2 is a perspective view of an exemplary differential pair group made up of differential via pairs in an electrical circuit, shown on two neighboring layers of the circuit.

FIG. 3 is a top view of a cross-section of the exemplary differential pair group of FIG. 2.

FIG. 4 is a flow chart of an exemplary operation for calculating worst case coupling in a differential pair group.

FIG. 5 is a flow chart of another exemplary operation for calculating worst case coupling in a differential pair group.

FIG. 6 is a block diagram of an exemplary computer system which may be used to calculate worst case coupling in a differential pair group.

### DESCRIPTION

The drawing and description, in general, disclose a method and apparatus for calculating worst case coupling within a differential pair group. This enables a designer to easily calculate the susceptibility of the differential pairs in the circuit to capacitive crosstalk, or interference caused by signals becoming partially superimposed on each other due to electrostatic. (capacitive) coupling between the conductors carrying the signals. The exemplary method and apparatus for calculating worst case coupling within a differential pair group may be used to calculate worst case coupling for either differential trace pairs, conductors running along a layer of a circuit (e.g., horizontally), or differential via pairs, conductors running between circuit layers (e.g., vertically). Alternative embodiments may calculate worst case coupling for differential pairs within other types of circuit layouts.

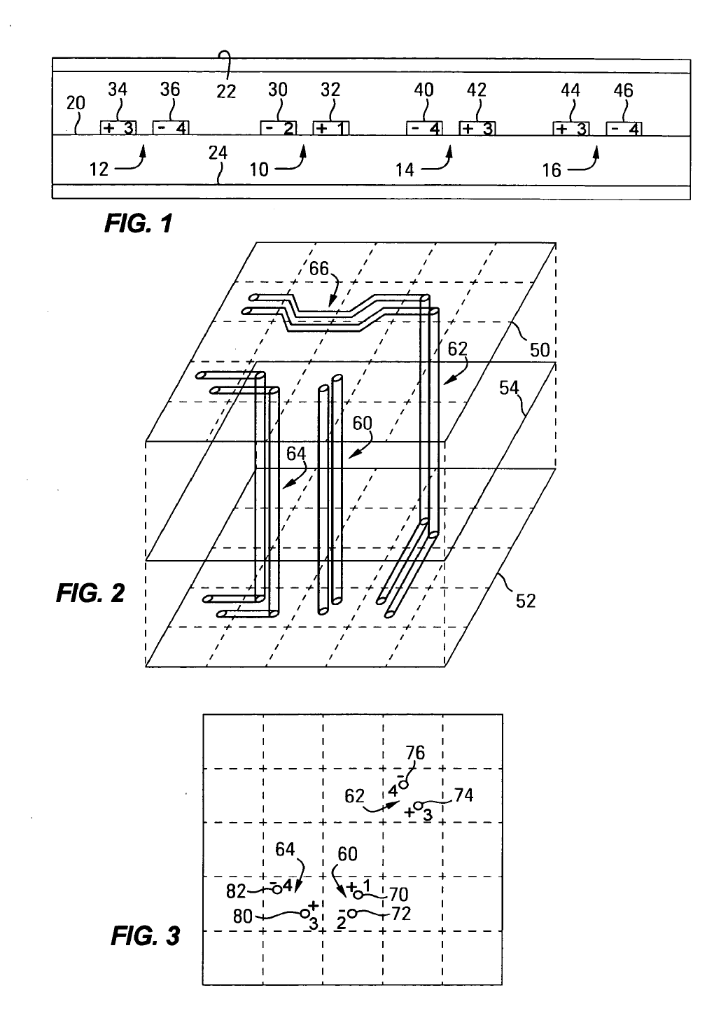

In one exemplary embodiment, the worst case coupling factor is calculated for a differential pair group, a group of differential pairs each having two conductive traces or vias. In one exemplary embodiment in which the victim differential pair is a pair of traces, the differential pair group is laid out on a single layer of an electrical circuit, as illustrated in FIG. 1. However, the method and apparatus for calculating worst case coupling within a differential pair group is not limited to this arrangement, and may calculate worst case coupling for differential trace pair groups spread across multiple layers, or for differential via pair groups located in a cross-sectional window around the victim differential via pair, with the cross-sectional window aligned parallel with the circuit layers. For example, in one alternative embodiment, the two conductors in a differential trace pair may be routed on two different layers, one above the other. One possible configuration would be to have four stacked layers, with the top and bottom layers containing ground planes, the two middle layers each containing one of the conductors in the differential trace pair. This configuration of differential trace pairs may be included in a differential pair group and in the coupling calculations, as well as other configurations of differential pairs.

In one exemplary embodiment, the method and apparatus for calculating worst case coupling within a differential pair group is implemented as a software tool that may be executed by a circuit designer. Characteristics of a circuit layout may be provided as an input to the worst case coupling tool, which generates the worst case coupling factor for the differential pair group as output. For example, capacitance values for elements in the differential pair group may be provided as an input to the worst case coupling tool for use in calculating worst case coupling. Alternatively, a description of the physical layout of the differential pair group in a cross-section may be provided as an input to the worst case coupling tool for use in calculating worst case coupling.

One differential pair in the differential pair group is selected as the victim differential pair, with the remaining differential pairs in the differential pair group being selected as culprit differential pairs. The worst case coupling factor is an indication of the extent to which signals on the culprit differential pairs may couple to the victim differential pair. The differential pair group may contain any number of culprit differential pairs, from one to many. However, the contribution of culprit pairs to the worst case coupling factor typically drops off as the distance from the culprit differential pairs to the victim differential pair increases. In the exemplary embodiment, the differential pair group contains a single victim differential pair, and the worst case coupling to other differential pairs may be calculated by re-running the worst case coupling tool with the other differential pairs selected as victim.

The method and apparatus for calculating worst case coupling may be implemented in a standalone software tool, or may be built into electronic design automation (EDA) software such as Allegro or Advanced Package Designer (APD), available from Cadence Design Systems, Inc. of San Jose, Calif., or may be implemented as a script or macro within EDA software.

Referring now to FIG. 1, an exemplary differential pair group for which worst case coupling may be calculated will be described. The illustration of FIG. 1 contains a cross-sectional side view of the differential pair group, with the conductive traces running into and out of the paper. In the exemplary embodiment, the cross-section is taken perpendicularly to the victim differential pair, although the method and apparatus for calculating worst case coupling is not limited to this arrangement.

The exemplary differential pair group includes four differential trace pairs 10, 12, 14 and 16, all located on a single layer 20 of the circuit. In this exemplary circuit layout, ground planes 22 and 24 lie above and below the differential pair group's layer 20. One differential pair 10 is selected as the victim differential pair, and the remaining differential pairs 12, 14 and 16 are selected as the culprit differential pairs. Each differential trace pair 10, 12, 14 and 16 contains two conductive traces 30 and 32, 34 and 36, 40 and 42, and 44 and 46, respectively.

The two conductive traces in each differential trace pair are assigned a polarity, one positive and one negative, because each trace of the differential trace pair theoretically carries equal but opposite currents called odd-mode signals. In the exemplary circuit layout illustrated in FIG. 1, the victim differential pair 10 has a negative conductor 30 on the left and a positive conductor 32 on the right. The culprit differential pair 12 on the left of the victim differential pair 10 has a positive conductor 34 on the left and a negative conductor 36 on the right, so the common polarity (negative) conductors 30 and 36 of the victim differential pair 10 and the culprit differential pair 12 are adjacent. The culprit differential pair 14 just to the right of the victim differential pair 10 has a negative conductor 40 on the left and a positive conductor 42 on the right, so the opposite polarity conductors 32 and 40 of the victim differential pair 10 and the culprit differential pair 14 on the right are adjacent. The rightmost culprit differential pair 16 has a positive conductor 44 on the left and a negative conductor 46 on the right, so the common polarity (positive) conductors 32 and 44 of the victim differential pair 10 and the culprit differential pair 16 are closest.

The worst case coupling factor is calculated in the exemplary embodiment based on capacitance values for the elements of the differential pair group. Capacitance values for the elements of the differential pair group may be calculated in the worst case coupling tool or may be externally calculated and provided to the worst case coupling tool using well known electromagnetic solver techniques, based on parameters such as the dielectric material, the shape of the conductors and the spatial distribution of the conductors. The capacitance values for the worst case coupling calculation are found in the capacitance matrix for the victim differential pair 10 and culprit differential pairs (e.g., 12). The capacitance matrix for the system containing the victim differential pair 10 and one culprit differential pair, such as the left culprit differential pair 12, is as follows:

$$[ C ] = [ \begin{matrix}{C}_{11} & - {C}_{12} & - {C}_{13} & - {C}_{14} \\ - {C}_{21} & {C}_{22} & - {C}_{23} & - {C}_{24} \\ - {C}_{31} & - {C}_{32} & {C}_{33} & - {C}_{34} \\ - {C}_{41} & - {C}_{42} & - {C}_{43} & {C}_{44} \end{matrix} ]$$

where Cᵢⱼ=Cⱼᵢ. The subscripts in the capacitance matrix refer to individual conductors in the differential pairs 10 and 12. The conductive traces in the differential pair group illustrated in FIG. 1 have each been numbered with the numerals 1 through 4 corresponding to the capacitance matrix above. For example, the capacitance C₁₂ in the capacitance matrix is the capacitance between the positive trace 32 (identified as conductor 1) and the negative trace 30 (identified as conductor 2) of the victim differential pair 10. Similarly, the capacitance C₂₃ in the capacitance matrix is the capacitance between the negative trace 30 of the victim differential pair 10 and the positive trace 34 of the culprit differential pair 12. Again, the capacitance matrix is for the system including the victim differential pair 10 and one culprit differential pair, such as the left culprit differential pair 12.

The coupling factor k from a culprit differential pair (e.g., 12) to the victim differential pair 10 is calculated as follows:

$${k}_{21} = \frac{{C}_{13} + {C}_{24} - ( {C}_{14} + {C}_{23} )}{{C}_{11} + {C}_{22} - 2 {C}_{12}}$$

The subscripts to the left of the equality sign each identify a differential pair in the differential pair group, with the victim differential pair being number 1 and the culprit differential pair being number 2 in this case. The subscripts to the right of the equality sign each identify a conductor in the differential pair group. Note that the first two terms of the numerator are the capacitance values between traces having a common polarity in the victim differential pair and the culprit differential pair. The capacitance value C₁₃ is the capacitance between the positive traces 32 and 34 of the victim differential pair 10 and the culprit differential pair 12, respectively. The capacitance value C₂₄ is the capacitance between the negative traces 30 and 36 of the victim differential pair 10 and the culprit differential pair 12, respectively. The second two terms of the numerator are the capacitance values between traces having an opposite polarity in the victim differential pair and the culprit differential pair. The capacitance value C₁₄ is the capacitance between the positive trace 32 of the victim differential pair 10 and the negative trace 36 of the culprit differential pair 12. The capacitance value C₂₃ is the capacitance between the negative trace 30 of the victim differential pair 10 and the positive trace 34 of the culprit differential pair 12.

Because the capacitance value drops off as a function of distance, the coupling value k may be either positive or negative depending in part on whether the first two terms of the numerator in the k equation above are collectively greater than the last two terms of the numerator. For example, the coupling factor between the victim differential pair 10 and the left culprit differential pair 12 may be positive because the capacitance value C₂₄ is likely greatest, with the negative traces 30 and 36 of the victim differential pair 10 and the culprit differential pair 12 being closest together, and the capacitance value C₂₄ appearing in the positive portion of the numerator. In contrast, the coupling factor between the victim differential pair 10 and the culprit differential pair 14 to the right may be negative because the capacitance value C₁₄ is likely greatest, with the positive trace 32 of the victim differential pair 10 and the negative trace 40 of the culprit differential pair 14 being closest together, and the capacitance value C₁₄ appearing in the negative portion of the numerator. Of course, these are only speculative projections based on the layout illustrated in FIG. 1, and when actual numeric capacitance values are plugged into the coupling factor equation for k, the signs of the resulting coupling values may differ from the examples given above.

As with the capacitance matrix, the coupling factor k is calculated between the victim differential pair 10 and a single culprit differential pair 12, 14 or 16. The coupling factor between the victim differential pair 10 and each culprit differential pair 12, 14 and 16 in the differential pair group is calculated in turn. The resulting coupling factors are then combined to form a worst case coupling factor for the victim differential pair within the differential pair group. However, because the signs of the coupling factors may differ, with some being positive and some being negative, the coupling factors are not simply added, or they may cancel each other out to some degree. As discussed above, the polarities of the traces in the differential pair group are somewhat arbitrarily assigned by the circuit designer, and may not be an accurate indication of the actual state of the signals at all times during operation of the circuit. The method and apparatus for determining worst case coupling within a differential pair group therefore ensures that the various coupling factors do not cancel each other out when combining them to form the worst case coupling factor.

In one exemplary embodiment, this is done by summing the absolute values of the various coupling factors in the differential pair group as follows:

$${k}_{total} = {\sum }_{m = 2}^{N} \vert {k}_{m 1} \vert$$

As described above with respect to the individual coupling factor equation, the victim differential pair is identified as pair 1 and the culprit differential pairs are identified as 2 and up. The term N in the equation for kₜₒₜₐₗ is the number of differential pairs in the differential pair group (or 4 in the exemplary differential pair group of FIG. 1). For example, in the exemplary differential pair group illustrated in FIG. 1, the left culprit differential pair 12 may be differential pair 2 according to the notation above, the culprit differential pair 14 to the right of the victim differential pair 10 may be differential pair 3, and the rightmost culprit differential pair 16 may be differential pair 4. The equation for kₜₒₜₐₗ therefore adds the absolute value of the coupling factor k₂₁ between the left culprit differential pair 12 and the victim differential pair 10, plus the absolute value of the coupling factor k₃₁ between the culprit differential pair 14 on the right and the victim differential pair 10, plus the absolute value of the coupling factor k₄₁ between the rightmost culprit differential pair 16 and the victim differential pair 10.

In an alternative embodiment, the method and apparatus for determining worst case coupling within a differential pair group ensures that the various coupling factors do not cancel each other out by determining which polarity assignments in the differential pair group would maximize the worst case coupling factor kₜₒₜₐₗ when the various coupling factors are combined. This may be performed, for example, by a trial and error process of calculating and recalculating coupling factors while changing polarity assignments until all coupling factors have the same sign or until the worst case coupling factor is maximized. This may also be performed by comparing the magnitude of the common-polarity capacitance values and opposite-polarity capacitance values for a default polarity assignment, then selecting an actual polarity assignment that ensures that all coupling values have the same sign.

The method and apparatus for determining worst case coupling within a differential pair group ensures that the circuit designer is informed about the worst possible coupling within a differential pair group, enabling the designer to prevent unacceptable crosstalk levels in the circuit. It also greatly simplifies the calculation of worst case coupling because the designer need not determine what polarity assignments would maximize worst case coupling. If the designer happens to select the wrong polarity assignments, or if polarities change during operation of the circuit, the method and apparatus for determining worst case coupling within a differential pair group will still be able to calculate the worst possible coupling level in the differential pair group. This enables the designer to provide the coupling tolerance needed in the circuit to avoid unacceptable crosstalk levels, even if the polarity of the signals in the differential pair group changes during operation.

As discussed above, the method and apparatus for determining worst case coupling within a differential pair group may be applied to differential via pairs as well as differential trace pairs. Referring now to FIGS. 2 and 3, an exemplary differential via pair group for which worst case coupling may be calculated will be described. The illustration of FIG. 2 contains a perspective view of differential vias in the differential pair group running vertically between two layers 50 and 52 of a circuit. A cross-section is taken along plane 54 between the two layers 50 and 52, parallel with the two layers 50 and 52. Alternatively, the cross-section may be taken at an angle to the two layers 50 and 52 if desired. Furthermore, the location of the cross-section may be adjusted as desired, such as at one of the two layers 50 or 52 or at any location between, or at any position along the victim differential via pair 60.

FIG. 3 contains a top view of the cross-section of the differential pair group taken along plane 54 in FIG. 2. Dashed grid lines have been included in FIGS. 2 and 3 to aid in correlating differential via pairs between the figures. The exemplary differential pair group illustrated in FIGS. 2 and 3 includes one victim differential pair 60 and two culprit differential pairs 62 and 64. Some differential traces (e.g., 66) are shown in FIG. 2, but are not included in the worst case coupling calculation because they do not appear in the cross section. In the exemplary embodiment, only differential pairs running substantially parallel with the victim differential pair are included in the worst case coupling factor. Therefore, radial or horizontal traces are not included in a worst case coupling calculation for a victim differential via. However, in alternative embodiments, they may be included if desired, although some consideration may need to be made for the fact that they do not lie adjacent the victim differential pair for much of its length.

As with the differential trace pair above, the differential pair group may be bounded by specifying the differential pairs in the group to be considered, or by specifying a distance or window around the victim differential pair within which all differential pairs will be considered.

Because of the vertical orientation of the differential via pairs 60, 62 and 64, the exemplary differential via pair group does not lie on a single layer as with the exemplary differential trace pair group discussed above. (Note that the terms “vertical” and “horizontal” are used herein to refer to directions that are perpendicular and parallel, respectively, to circuit layers, and remain constant regardless of how the circuit is rotated.) Differential via pairs in the differential pair group may terminate on various layers of the circuit. For example, exemplary culprit differential pairs 62 and 64 terminate on layers 50 and 52 illustrated in FIG. 2, but the exemplary victim differential pair 60 continues beyond layers 50 and 52 in both directions. The coupling factors discussed herein are calculated for cross-sections of differential pair groups and are not, by themselves, indications of integral coupling factors along entire lengths of differential pairs.

The calculation of the worst case coupling factor for the differential via pair group is performed as described above with respect to the differential trace pair group. The individual coupling factors between each culprit differential pair 62 and 64 and the victim differential pair 60 are calculated according to the following equation:

$${k}_{21} = \frac{{C}_{13} + {C}_{24} - ( {C}_{14} + {C}_{23} )}{{C}_{11} + {C}_{22} - 2 {C}_{12}}$$

As above with respect to the differential trace pair group, the subscripts to the left of the equality sign each identify a differential pair in the differential pair group, and the subscripts to the right of the equality sign each identify a conductor in the differential pair group. Note that a polarity has been assigned to each trace in the differential pair group, but as discussed above, this is somewhat arbitrary and will not affect the value of the worst case coupling factor. Again, the victim differential pair 60 is designated as pair number 1 for the k₂₁ coupling factor equation above, a first culprit differential pair 62 is designated as pair number 2, and a second culprit differential pair 64 is designated as pair number 3. The positive conductor 70 of the victim differential pair 60 is designated as conductor number 1 for the k coupling factor equation above, and the negative conductor 72 is designated as conductor number 2. For calculating k₂₁, the coupling factor between the first culprit differential pair 62 and the victim differential pair 60, the positive conductor 74 of the first culprit differential pair 62 is designated as conductor number 3, and the negative conductor 76 is designated as conductor number 4. For calculating k₃₁, the coupling factor between the second culprit differential pair 64 and the victim differential pair 60, the positive conductor 80 of the second culprit differential pair 64 is designated as conductor number 3, and the negative conductor 82 is designated as conductor number 4.

The individual coupling factors are then combined to form the worst case coupling factor, for example using the following equation:

$${k}_{total} = {\sum }_{m = 2}^{N} \vert {k}_{m 1} \vert$$

The worst case coupling factor kₜₒₜₐₗ would be the sum of the absolute value of the first individual coupling factor k₂₁, the coupling factor between the first culprit differential pair 62 and the victim differential pair 60, plus the absolute value of the second individual coupling factor k₃₁, the coupling factor between the second culprit differential pair 64 and the victim differential pair 60.

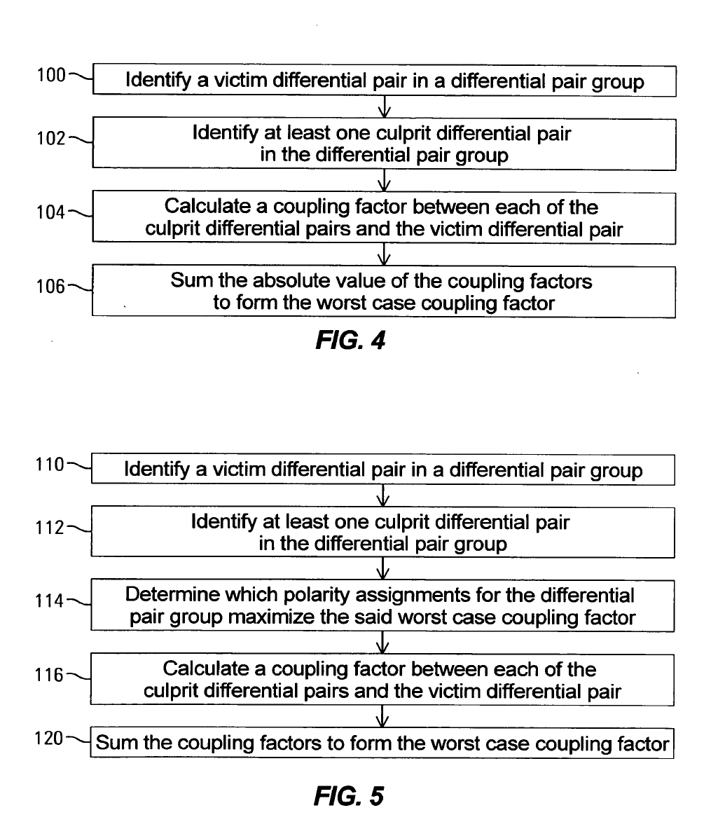

An exemplary operation for calculating the worst case coupling factor within a differential pair group is summarized in FIG. 4. A victim differential pair is identified 100 in a differential pair group, and at least one culprit differential pair is identified 102 in the differential pair group. A coupling factor between each of the culprit differential pairs and the victim differential pair is calculated 104. The worst case coupling factor is then formed by summing 106 the absolute value of the individual coupling factors between the victim differential pair and each of the culprit differential pairs. As discussed above, the coupling factor calculations are performed based on a cross-section of the differential pair group, and may be based on capacitance values of elements in the differential pair group, either calculated as part of the worst case coupling calculation process or provided as an input to the process. If the capacitance values are calculated as part of the worst case coupling calculation process, the layout of the cross-section may be provided as an input to the worst case coupling tool. For example, physical measurements including conductor size, spatial relationships between conductors including direction and distance may be provided, as well as any other needed parameters such as properties of the dielectric material between the conductors.

An alternative exemplary operation for calculating the worst case coupling factor within a differential pair group is summarized in FIG. 5. A victim differential pair is identified 110 in a differential pair group, and at least one culprit differential pair is identified 112 in the differential pair group. Polarity assignments for the differential pair group are identified 114 which would maximize the worst case coupling factor, and a coupling factor between each of the culprit differential pairs and the victim differential pair is calculated 116. The worst case coupling factor is then formed by summing 120 or otherwise combining the individual coupling factors.

As discussed above, an exemplary embodiment of a tool for calculating worst case coupling may be implemented in any desired fashion, such as in a standalone software tool or in conjunction with EDA software. The inputs may also be adapted as desired. For example, the layout of a cross-section of a differential pair group may be provided as an input, along with material properties, etc. Alternatively, capacitance values for a differential pair group may be provided as an input. In another alternative, a circuit design database may be provided as an input, from which the layout of a cross-section of a differential pair group may be determined, along with an indication of the differential pair group to be considered.

Similarly, the outputs may be adapted as desired. For example, the resulting worst case coupling factor may be displayed, stored in a file, or provided as input to another software application taking part in the circuit design process.

Exemplary embodiments of the method and apparatus for calculating worst case coupling within a differential pair group have been described herein as they apply to differential traces and vias in a layered circuit layout. However, the method and apparatus for calculating worst case coupling is not limited to these applications, and may be applied to any type of circuit layout in which coupling factors between differential pairs may be calculated.

An exemplary embodiment of an apparatus for calculating worst case coupling within a differential pair group may comprise computer readable program code stored on at least one computer readable medium. The exemplary computer readable program code includes code for calculating individual coupling values between a victim differential pair and each culprit differential pair in a differential pair group. The exemplary computer readable program code also includes code for calculating a worst case coupling value for the differential pair group based on the individual coupling values, with the worst case coupling value being maximized for any possible configuration of polarity assignments for conductors in the differential pair group.

Various computer readable or executable code or electronically executable instructions have been referred to herein. These may be implemented in any suitable manner, such as software, firmware, hard-wired electronic circuits, or as the programming in a gate array, etc. Software may be programmed in any programming language, such as machine language, assembly language, or high-level languages such as C or C++. The computer programs may be interpreted or compiled.

Computer readable or executable code or electronically executable instructions may be tangibly embodied on any computer-readable storage medium or in any electronic circuitry for use by or in connection with any instruction-executing device, such as a general purpose processor, software emulator, application-specific circuit, a circuit made of logic gates, etc. that can access or embody, and execute, the code or instructions.

Methods described and claimed herein may be performed by the execution of computer readable or executable code or electronically executable instructions, tangibly embodied on any computer-readable storage medium or in any electronic circuitry as described above.

A storage medium for tangibly embodying computer readable or executable code or electronically executable instructions includes any means that can store, transmit, communicate, or in any way propagate the code or instructions for use by or in connection with the instruction-executing device. For example, the storage medium may include (but is not limited to) any electronic, magnetic, optical, or other storage device, or any transmission medium such as an electrical conductor, an electromagnetic, optical, infrared transmission, etc. The storage medium may even comprise an electronic circuit, with the code or instructions represented by the design of the electronic circuit. Specific examples include magnetic or optical disks, both fixed and removable, semiconductor memory devices such as memory cards and read-only memories (ROMs), including programmable and erasable ROMs, non-volatile memories (NVMs), optical fibers, etc. Storage media for tangibly embodying code or instructions also include printed media such as computer printouts on paper which may be optically scanned to retrieve the code or instructions, which may in turn be parsed, compiled, assembled, stored and executed by an instruction-executing device. The code or instructions may also be tangibly embodied as an electrical signal in a transmission medium such as the Internet or other types of networks, both wired and wireless.

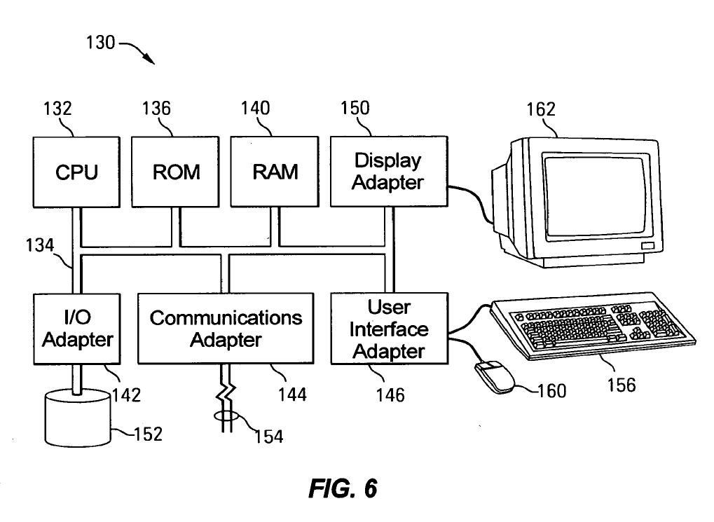

An exemplary computer system which may be used to calculate worst case coupling within a differential pair group is illustrated in the block diagram of FIG. 6. The computer system 122 includes a central processing unit (CPU) 132 which includes support for synchronization of asynchronous interrupts, as will be described below. The CPU 132 is connected by a system bus 134 to devices such as a read-only memory (ROM) 136, a random access memory (RAM) 140, an input/output (I/O) adapter 142, a communications adapter 144, a user interface adapter 146, and a display adapter 150. Data storage devices such as a hard drive 152 are connected to the computer system 130 through the I/O adapter 142. In operation, the CPU 132 in the computer system 10 executes instructions stored in binary format on the ROM 136, on the hard drive 152, and in the RAM 140, causing it to manipulate data stored in the RAM 140 to perform useful functions. The computer system 130 may communicate with other electronic devices through local or wide area networks (e.g., 154) connected to the communications adapter 144. User input is obtained through input devices such as a keyboard 156 and a pointing device 160 which are connected to the computer system 130 through the user interface adapter 146. Output is displayed on a display device such as a monitor 162 connected to the display adapter 150. Calculation of worst case coupling may be performed on such a computer system 130, or any other suitably configured processing system.

While illustrative embodiments have been described in detail herein, it is to be understood that the concepts disclosed herein may be otherwise variously embodied and employed, and that the appended claims are intended to be construed to include such variations, except as limited by the prior art.

1. A computer-implemented method for calculating worst case coupling for a differential pair group, comprising:
identifying a victim differential pair in said differential pair group;
identifying at least one culprit differential pair in said differential pair group;
calculating a coupling factor between each of said at least one culprit differential pairs and said victim differential pair; and
calculating a worst case coupling factor based on said at least one coupling factors, wherein said worst case coupling factor has a maximum possible amplitude for any polarity assignments in said differential pair group.

2. The method of claim 1, wherein each differential pair in said differential pair group comprises two conductors, one of which is assigned a positive polarity and another of which is assigned a negative polarity for said calculating said coupling factor.

3. The method of claim 1, said calculating said worst case coupling factor comprising summing an absolute value of said at least one coupling factors.

4. The method of claim 1, said calculating said worst case coupling factor comprising determining which polarity assignments for said differential pair group maximize said amplitude of said worst case coupling factor.

5. The method of claim 4, said calculating said worst case coupling factor comprising summing said at least one coupling factors.

6. The method of claim 1, wherein said at least one culprit differential pair comprises a plurality of culprit differential pairs.

7. The method of claim 1, wherein said differential pair group comprises a group of differential traces lying on a single layer of an electrical circuit.

8. The method of claim 1, wherein said differential pair group includes at least one differential trace pair lying on multiple layers of an electrical circuit.

9. The method of claim 1, wherein said differential pair group comprises a group of differential vias between a plurality of layers of an electrical circuit.

10. The method of claim 1, further comprising providing a layout of a cross-section of said differential pair group for use in said calculating said at least one coupling factors.

11. The method of claim 10, further comprising calculating capacitance values for said differential pair group based on said layout.

12. The method of claim 1, wherein said at least one coupling factors are calculated based on capacitance values in said differential pair group.

13. An apparatus for calculating worst case coupling in a differential pair group, comprising:
a. at least one computer readable medium; and
b. computer readable program code stored on said at least one computer readable medium, said computer readable program code comprising:
i. program code for calculating a plurality of coupling values for said differential pair group, each of said plurality of coupling values indicating a coupling level between a victim differential pair and a unique one of a plurality of culprit differential pairs in said differential pair group; and
ii. program code for calculating a worst case coupling value for said differential pair group based on said plurality of coupling values, wherein said worst case coupling value is maximized for any possible configuration of polarity assignments for conductors in said differential pair group.

14. The apparatus of claim 13, further comprising program code for calculating capacitance values for each differential pair in said differential pair group based on a cross-section of said differential pair group.

15. The apparatus of claim 14, wherein said plurality of coupling values are calculated based on said capacitance values.

16. The apparatus of claim 13, wherein said program code for calculating said plurality of coupling values comprises program code for calculating said plurality of coupling values based on differential traces located on a single layer of an electrical circuit.

17. The apparatus of claim 13, wherein said program code for calculating said plurality of coupling values comprises program code for calculating said plurality of coupling values based on differential vias between a plurality of layers in an electrical circuit.

18. The apparatus of claim 13, wherein said program code for calculating said worst case coupling value comprises program code for summing an absolute value of each of said plurality of coupling values.

19. The apparatus of claim 13, wherein said program code for calculating said worst case coupling value comprises program code for determining which configuration of said polarity assignments for said conductive traces in said differential pair group would result in a greatest value for said worst case coupling value when said worst case coupling value is calculated by summing said plurality of coupling values.

20. The apparatus of claim 19, wherein said program code for determining which configuration of said polarity assignments for said conductive traces in said differential pair group would result in said greatest value comprises program code for determining which configuration of said polarity assignments would result in all of said plurality of coupling values having a same sign.

21. An apparatus for calculating worst case coupling in a differential pair group, comprising:
means for calculating coupling factors between each of a plurality of culprit differential pairs in said differential pair group and a victim differential pair in said differential pair group; and
means for calculating a worst case coupling factor from said coupling factors, wherein said worst case coupling factor is as great as possible given all possible combinations of polarity assignments for said differential pair group during said calculating.
